(19) United States
(12) Patent Application Publication
(10) Pub. No.: US 2004/0024623 A1
(43) Pub. Date: Feb. 5, 2004

(54) Method and system for leveraging functional knowledge in an engineering project

(76) Inventors: Lawrence A. Ciscon, Houston, TX (US); Eugene P. Giles, Houston, TX (US); David E. Easterby, Kingwood, TX (US); Donna G. Rabalais, Kingwood, TX (US); Bernard T. Barcio, Pearland, TX (US); Keith L. Smith, Houston, TX (US); Mary T. Fuzat, Pearland, TX (US)

Correspondence Address: Jonathan P. Osha, Rosenthal & Osha L.L.P., Suite 2800, 1221 McKinney Street, Houston, TX, 77010, US

(21) Appl. No.: 10/209,531

(22) Filed: Jul. 31, 2002

(51) Int. Cl. G06F 17/60

(52) U.S. Cl. 705/7

(57) ABSTRACT

A method of leveraging functional knowledge in an engineering project includes obtaining a first requirement of the engineering project, creating a first attributed entity, associating the first attributed entity with the first requirement to obtain a first attributed requirement, obtaining a second requirement of the engineering project, creating a second attributed entity, associating the second attributed entity with the second requirement to obtain a second attributed requirement, defining a plurality of constraints based on at least one of the first attributed requirement and the second attributed requirement, applying the plurality of constraints if one of the first attributed requirement and the second attributed requirement is modified, and providing notice if at least one of the plurality of constraints is violated.

### BACKGROUND OF INVENTION

An engineering process is the process of devising a system, component, or process to meet the desired needs of a customer. The engineering process applies the basic sciences, mathematics, and engineering sciences to convert resources to produce a solution. The engineering process strives to produce a solution that satisfactorily performs the required functions while using a minimum of materials, minimizing costs, and still being aesthetically pleasing. In practice, the engineering process has a balance of ideal aims and practical limitations. The role of the engineering firm is during the engineering process is to communicate and coordinate the activity of personnel within the engineering firm and the supply chain (i.e., the suppliers and subcontractors) necessary to complete an engineering project.

FIG. 1 shows a flow chart of a typical engineering process. The requirements are gathered by a designer, architect, or engineer from the customer (Step 10). The requirements that are gathered may include information detailing the parameters of the overall engineering project, such as customer contact information, desired budget, scope of project, financer of project, time frame, proposed completion date, etc. The goal of requirements gathering is to gather as much information about the engineering project as possible. A lack of information or misinformation gathered early in the engineering process can translate into a host of mistakes and overruns.

Using the requirements gathered from the customer, the engineer may communicate with a designer to prepare a preliminary design (Step 12). While creating the preliminary design, the initial overall system configuration is defined, and a schematic, layout, definition drawing, or other engineering documentation is created. The preliminary design may be revised through a series of design iterations, if design modifications are necessary (Step 14). During the design iterations, the requirements may require change due to ongoing meetings between the customer and the architect, engineer, or designer.

A detail design is produced (Step 16) by the designer based on the preliminary design using design tools. The detailed design is a proven and tested design of the engineering project that may also involve some design iterations before being approved by the customer, engineer, and/or architect.

Upon approval of the detailed design, a system of design documents, e.g., CAD drawings, object model diagrams, etc., are generated (Step 18). The advent of software design tools has had an enormous impact on the process of design documents preparation and generation. Depending on the type of solution being engineered, these software design tools may range from a tool such as Rational Rose® (Rational Rose® is a registered trademark of Rational Corporation located in San Francisco, Calif.) for the software industry to AutoCAD® (AutoCAD® is a registered trademark of Autodesk Corporation located in San Rafael, Calif.) for the construction industry.

Once the design documents have been produced, bids are solicited and evaluated by the engineering firm (Step 20). Subcontractors and the suppliers (collectively referred to as the supply chain) submit bids based on the design documents (supplied by the engineering firm). The bids may be submitted for portions of the engineering project or the entire engineering project. Once the bids have been submitted, the engineering firm evaluates the bids and select members of the supply chain to perform the various phases of the development of the engineering project.

Acquiring various licenses or permits (Step 22) may be required before commencing development the engineering project. Included within licenses, in this context, are land permits in the construction industry or licensing agreements in the technology industry.

Once the licenses are acquired, the engineering firm with the assistance of the supply chain develops the engineering project (Step 24). The development of the engineering project is usually the most time-consuming task involved in the engineering process and also where communication between all the participants involved in the engineering process is essential.

Once the development of the engineering project is completed, the customer (and any other required entities, e.g., municipality) performs a final inspection of the engineering project (Step 26). Based on a comparison between the agreed-upon design documents and the project as completed, the customer accepts or rejects the engineering project. If the customer accepts the engineering project, the closing is performed (Step 28). In the closing, all necessary documentation is signed and the legal interest in the engineering project is transferred to the customer.

FIG. 2 shows the communication flow involved in a typical engineering process. Requirements gathered from the customer (50), go through multiple potential handoffs before the requirements reach the participants that develop the engineering project (i.e., the engineering firm with the assistance of the supply chain (30)).

The requirements are communicated from a customer (50) to a designer (52), architect, or engineer via verbal communication, handwritten notes, faxes, e-mails, etc. The designer (52) designs the design documents of the engineering project and communicates (verbally or in writing) the design documents to a project manager (54). In turn, the project manager (54) retains some design documents and passes appropriate design documents to the site manager (56). The site manager (56) communicates (verbally or in writing) the information together with any appropriate design documents to the supply chain (30) (i.e., the subcontractors (32A-32N) and the suppliers (34A-34N)). Often, direct verbal communication (58) occurs between the customer (50) and the supply chain (30) (i.e., the subcontractors (32A-32N) and the suppliers (34A-34N)) with no written record to the other individuals participating in the engineering process.

An example of the engineering process performed as described in FIG. 1 and FIG. 2 occurs in the construction industry. In the construction industry, requirements are mostly communicated verbally from a customer to a builder. The builder then acts in a similar manner as the engineering firm described above. A designer asks for general requirement information concerning the overall construction project. The questions may include information such as the customer contact information, the total desired budget, the house size, the number of floors, and the house style. Also, the designer seeks information necessary to determine the specification of the lot size, how far back the house sits on the lot, the desired or known lot topology, the desired direction the house should face, etc. Most of this information is conveyed to the builder using existing floor plans, hand-drawn sketches, and/or verbal communication.

One software tool used to gather requirements in the construction industry is BSD Perspective™ (Perspective™ is a trademark of Building System Design, Inc. located in Atlanta, Ga.). BSD Perspective™ is a database that provides a repository for basic customer requirement information and is used as a starting point for the designer and customer. Another similar tool is Software Environment to Support Early Phases in Building Design (SEED). SEED attempt to improve design/build processes by changing the way in which architects and designers capture and use project information. SEED incorporates a hierarchical model of components of a building and a concept of requirements placed upon these components that is domain-specific. SEED does not export information or interface into existing design tools.

The designer prepares a preliminary design using the requirement information. This design may include hand drawn or computer-aided sketches of a house, basic construction schedule, etc. One example of a software tool that facilitates the preliminary design sketches is @Last Software's Sketchup™ (Sketchup is a trademark of @Last Software Corporation located in Boulder, Colo.). The sketches that are produced by Sketchup™ are visually and cosmetically-oriented rather than geometrically-oriented. Using such sketches, after a few meetings between the designer and the customer, the designer can gather enough information to produce the detail design.

Currently, in the construction industry, builders use 3D modeling systems as design tools to complete the detail design. A number of advanced CAD design systems are in wide use. These systems enable designers to interactively create 3D representations of a house and to generate construction drawing and other visualizations of the house. One of the most widely used CAD software packages is AutoCAD® from the AutoDesk Corporation. The AutoDesk Corporation provides many varieties of CAD software products. For example, an advanced CAD software package called Architectural Desktop with ObjectARX™ (Architectural Desktop with ObjectARX™ is a trademark of the AutoDesk Corporation located in San Rafael, Calif.) is an object-oriented CAD tool. With such an object-oriented CAD tool, drawings with architectural objects can be created. These drawings have more meaning than the traditional line drawings of CAD; however, knowledge of relationships among the architectural objects does not exist beyond the basic structural definitions.

The output of the detail design in the construction industry is construction documents. For a residential house project, the construction documents include a set of plans, including an elevation plan, a foundation plan, floor plans, a cross-section plan, structural details, interior details, a mechanical plan, an electrical plan, a plumbing plan, a specification details, etc.

While the builder typically handles some portion of the physical construction in-house, the majority of the work done on an average structure is completed by subcontractors. The builder only handles 20-30% of the physical construction in-house; the remainder of the project is to interact with the customer, suppliers, and subcontractors, and to manage the overall construction process. Thus, project management becomes a critical piece of the project.

Project management is commonly performed by a project manager that uses a project management solution, such as Microsoft® Project (Microsoft® Project is a registered trademark of Microsoft Corporation located in Redmond, Wash.). Microsoft® Project is commonly used in the construction industry, but is not tailored to or integrated with any one particular industry. Using Microsoft® Project, the project manager is able to track the construction of the house using the available information communicated by the suppliers, subcontractors, designers, and customers. If the information is not communicated to the project manager or the project manager does not enter the information into Microsoft® Project, the ability to effectively manage the project is limited.

Once the suppliers and subcontractors have submitted bids, the licenses need to be acquired before starting construction of the house. In the construction industry, this requires such tasks as securing permits for land, water usage permits, electrical hook-up permits, septic permits, utility permits, homeowner association approval, etc.

Once all the necessary licenses have been obtained, the subcontractors (32) (e.g., electricians, plumbers, framers, audio/visual technicians, cabinet makers, etc.) are able to commence construction of the house. Upon completion of the house, a final inspection is performed. The municipality, the appraiser, and/or the customer may perform a final inspection. The municipality is given an opportunity to inspect the house to determine whether the house meets all the necessary standards and building codes required by that municipality. During the inspection, the appraiser compares the completed house with the construction documents and all modifications given to the various individuals involved in the project. Finally, the customer may also inspect the house to determine whether the house meets the customer's expectations. Often, the customer is not satisfied with the completed house because of reasons such as the color of the carpet is wrong, the room size is not as indicated in the plans, a phone outlet is missing, etc. For a residential house project, after the municipality, appraiser, and customer's approval, the house closing involves the builder transferring ownership of the house and handing the title, site plan, inspection report, and warranties to the customer.

Additional software tools exist to help ease the challenges discussed above. Buzzsaw™ (Buzzsaw™ is a trademark of Autodesk Corporation located in San Rafael, Calif.) is an example of a software tool that can be used to address the permit, construction, and final inspection tasks of the construction process. Buzzsaw™ provides an online location for document sharing and collaboration.

SelectOnSite™ (SelectOnSite™ is a trademark of Solution On Site Corporation located in Lincolnshire, Ill.) is an example of a software tool to help facilitate the bidding process and provide a productivity tool for the subcontractors and suppliers. SelectOnSite™ enables a builder to offer customers an interactive interface for choosing room finish details and to tie this selection directly to the supplier for such features as pricing and availability. Thus, SelectOnSite™ provides customer interaction by offering pre-selected options defined by the builder, but is unable to gather or track the customer's specific project requirements or fit a design to these requirements.

Another software tool, BuildPoint™ (BuildPoint™ is a trademark by BuildPoint Corporation located in Redwood Shores, Calif.) is aimed at addressing the needs of the subcontractor and the suppliers in the supply chain. BuildPoint™ provides a directory and selection process for subcontractors bidding on a project. BuildPoint™ acts as a clearing-house for subcontractor selection and subcontractor coordination. Also, BuildPoint™ provides on-line document exchange capabilities that depend upon existing documentation and design tools for capturing and tracking program requirements and project information.

Communication between the numerous participants involved in the engineering process, as discussed above, is essential and easily becomes unmanageable. Therefore, the use of information technology can be highly effective during the engineering process.

Even when using the current software tools and information technology, communication of the necessary information between participants during the engineering process can be challenging. The necessary information is often contained in multiple applications with each application having a separate database. Typically, the information possessed by one participant is not necessarily the same as the other participants, and no single participant has access to all of the information stored in all the separate databases. In addition, information received and processed during the engineering process often has relationships with other information. Thus, a change in one piece of information may have a dramatic effect on the other piece of information. The fact that the two pieces of information are not located in the same database often means valuable information may be lost.

### SUMMARY OF INVENTION

In general, one aspect of the invention involves a method of leveraging functional knowledge in an engineering project. The method comprises obtaining a first requirement of the engineering project, creating a first attributed entity, associating the first attributed entity with the first requirement to obtain a first attributed requirement, obtaining a second requirement of the engineering project, creating a second attributed entity, associating the second attributed entity with the second requirement to obtain a second attributed requirement, defining a plurality of constraints based on at least one of the first attributed requirement and the second attributed requirement, applying the plurality of constraints if one of the first attributed requirement and the second attributed requirement is modified, and providing notice if at least one of the plurality of constraints is violated.

In general, one aspect of the invention involves a computer system to leverage functional knowledge in an engineering project. The computer system comprises a processor, a memory, a display device, and software instructions stored in the memory for enabling the computer system under control of the processor. The software instructions to perform: obtaining a first requirement of the engineering project, creating a first attributed entity, associating the first attributed entity with the first requirement to obtain a first attributed requirement, obtaining a second requirement of the engineering project, creating a second attributed entity, associating the second attributed entity with the second requirement to obtain a second attributed requirement, defining a plurality of constraints based on at least one of the first attributed requirement and the second attributed requirement, applying the plurality of constraints if one of the first attributed requirement, and the second attributed requirement is modified, and providing notice if at least one of the plurality of constraints is violated.

In general, one aspect of the invention involves an apparatus for leveraging functional knowledge in an engineering project. The apparatus comprises means for obtaining a first requirement of the engineering project, means for creating a first attributed entity, means for associating the first attributed entity with the first requirement to obtain a first attributed requirement, means for obtaining a second requirement of the engineering project, means for creating a second attributed entity, means for associating the second attributed entity with the second requirement to obtain a second attributed requirement, means for defining a plurality of constraints based on at least one of the first attributed requirement and the second attributed requirement, means for applying the plurality of constraints if one of the first attributed requirement and the second attributed requirement is modified, and means for providing notice if at least one of the plurality of constraints is violated.

In general, one aspect of the invention involves a system to leverage functional knowledge in an engineering process. The system comprises a functional knowledge repository created by modeling a plurality of requirements of the engineering project, and a plurality of project tools interfacing with the functional knowledge repository.

In general, one aspect of the invention involves an applied functional knowledge repository. The applied functional knowledge repository comprises a plurality of abstraction layers modeling a plurality of requirements of an engineering project, an input module allowing the input of the plurality of requirements into the plurality of abstraction layers, and an output module allowing leveraging of the plurality of requirements from the plurality of abstraction layers.

Other aspects and advantages of the invention will be apparent from the following description and the appended claims.

### BRIEF DESCRIPTION OF DRAWINGS

FIG. 1 shows a flow chart of a typical engineering process.

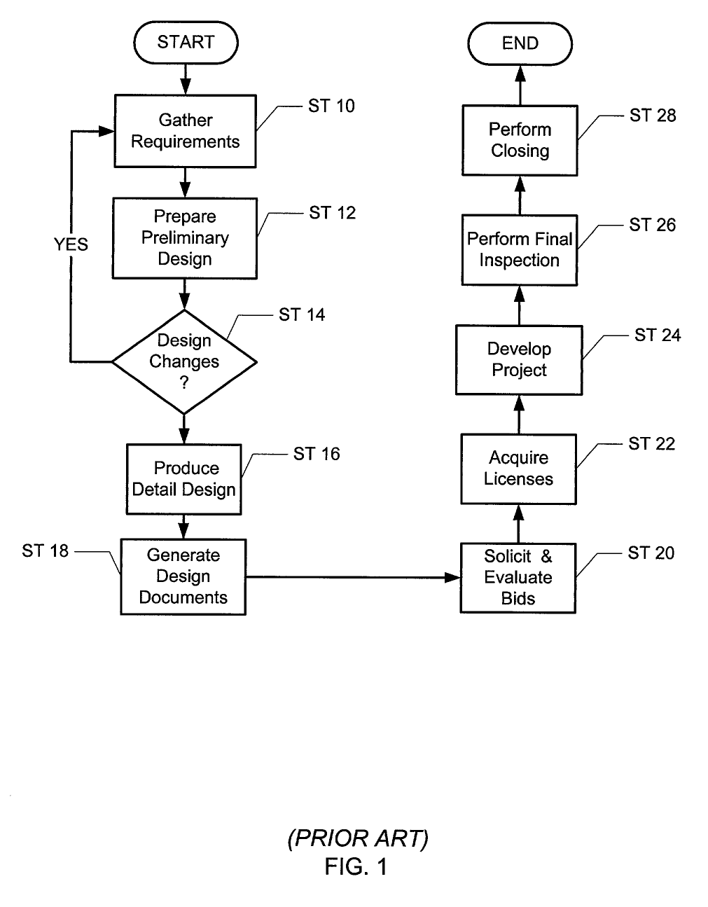

FIG. 2 shows a flow diagram of the communication flow during a typical engineering process.

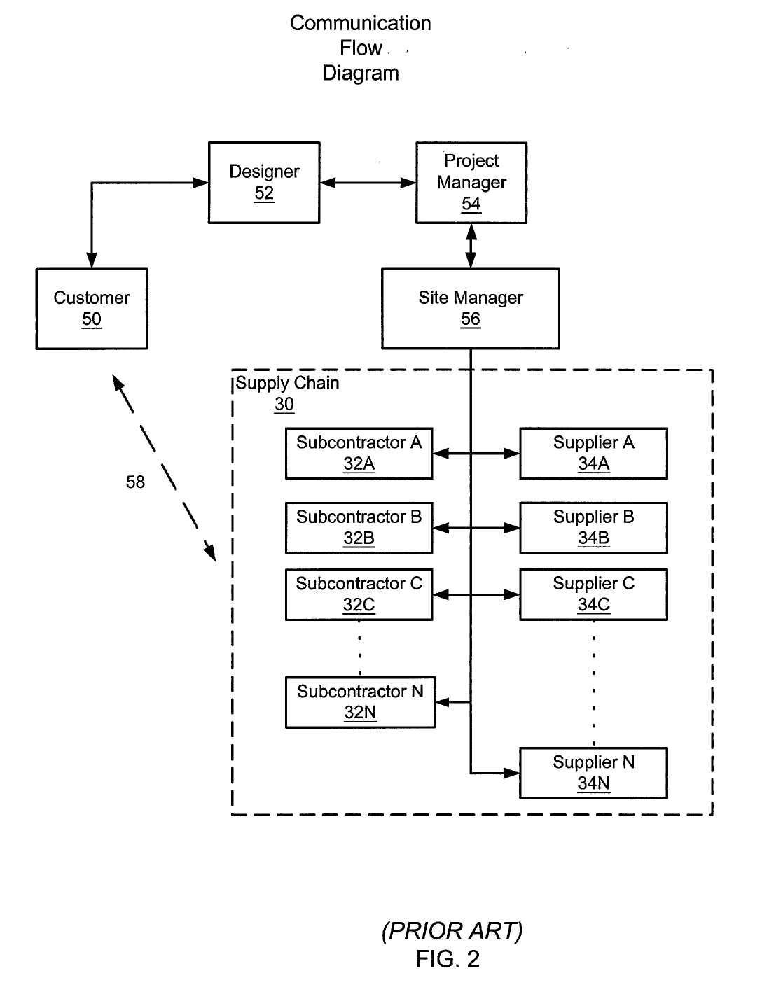

FIG. 3 shows a typical networked computer system.

FIG. 4 shows a block diagram of the components involved in an engineering process in accordance with one or more embodiments of the invention.

FIG. 5 shows a computer screenshot in accordance with one or more embodiments of the invention.

FIG. 6 shows a computer screenshot in accordance with one or more embodiments of the invention.

FIG. 7 shows a block diagram of the applied functional knowledge (AFK) repository in accordance with one or more embodiments of the invention.

FIG. 8 shows a uniform modeling language (UML) diagram of an entity-relation-constraint data store in the AFK repository in accordance with one or more embodiments of the invention.

FIG. 9 shows a UML diagram of a geometric entity model in the AFK repository in accordance with one or more embodiments of the invention.

FIG. 10 shows a UML diagram of taxonomy in the AFK repository in accordance with one or more embodiments of the invention.

FIG. 11 shows a UML diagram of the persistent mechanism in the AFK repository in accordance with one or more embodiments of the invention.

FIG. 12 shows a flow chart of leveraging an applied functional knowledge repository in an engineering project in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of the invention, numerous specific details are set forth in order to provide a more thorough understanding of the invention. However, the invention will be apparent to one of ordinary skill in the art that the invention may be practiced without these specific details. In other instances, well-known features have not been described in detail to avoid obscuring the invention.

The invention relates to a method for leveraging functional knowledge while creating a solution during an engineering process. Functional knowledge is knowledge not only of the components required to create the solution, but also of the intended functions of and constraints imposed on those components within the solution. For example, functional knowledge may include information about the valid entities in a space, the use of the entities, relationships between these entities, and constraints between entities.

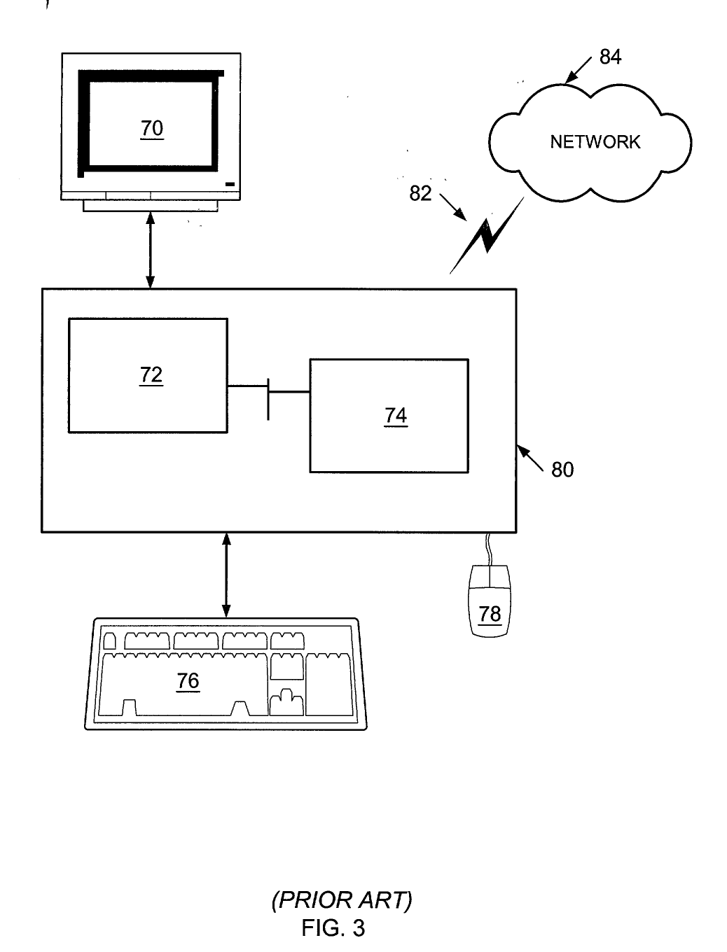

The present invention may be implemented on virtually any type computer, regardless of the platform being used. For example, as shown in FIG. 3, a computer (80) includes a processor (72), memory (74), a storage device (74), and numerous other elements and functionalities typical of today's computers (not shown). The computer (80) may also include input means, such as a keyboard (76) and a mouse (78), and an output device, such as a display device (70). Those skilled in the art will appreciate that these input and output means may take other forms in an accessible environment. The computer (80) may be connected to a wide area or a local area network via a network connection (82). The computer system may have multiple processors and may be configured to handle multiple tasks.

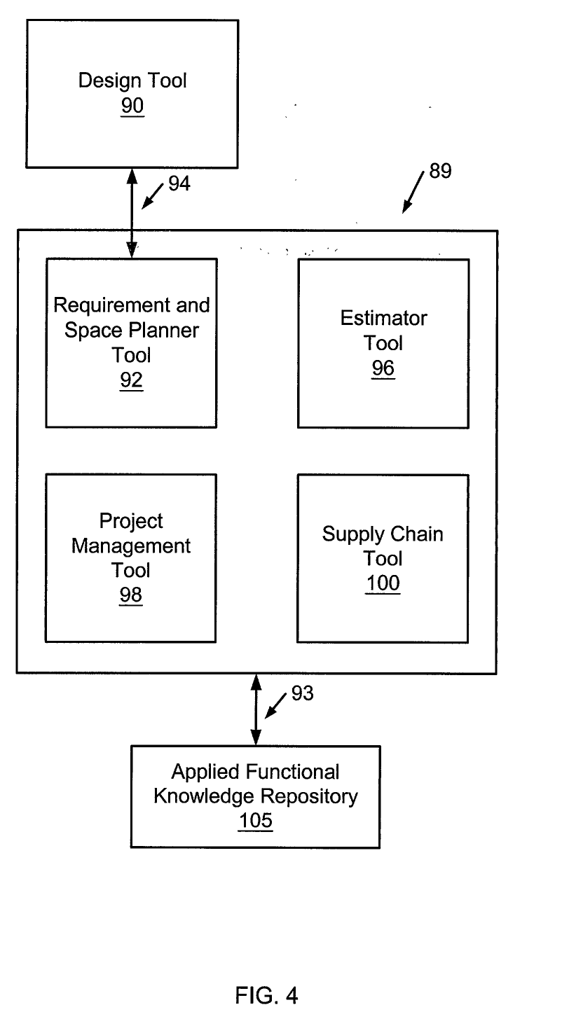

As shown in FIG. 4, functional knowledge may be leveraged in the engineering process by accessing the information contained within an applied functional knowledge (AFK) repository (105). The AFK repository (105) stores information about a specific engineering project (stored as functional knowledge) and is accessible by all participants in the engineering project (both inside and outside the engineering firm) allowing for improved communication. Several project tools (89) may access the AFK repository (105) during the engineering process, including a Requirement and Space Planner Tool (RSPT) (92), an Estimator Tool (ET) (96), a Project Management Tool (PMT) (98), a Supply Chain Tool (SCT) (100). In accordance with one or more embodiments of the invention, the tools can be stand-alone applications or interfaces that communicate with third party software, such as a design tool (90).

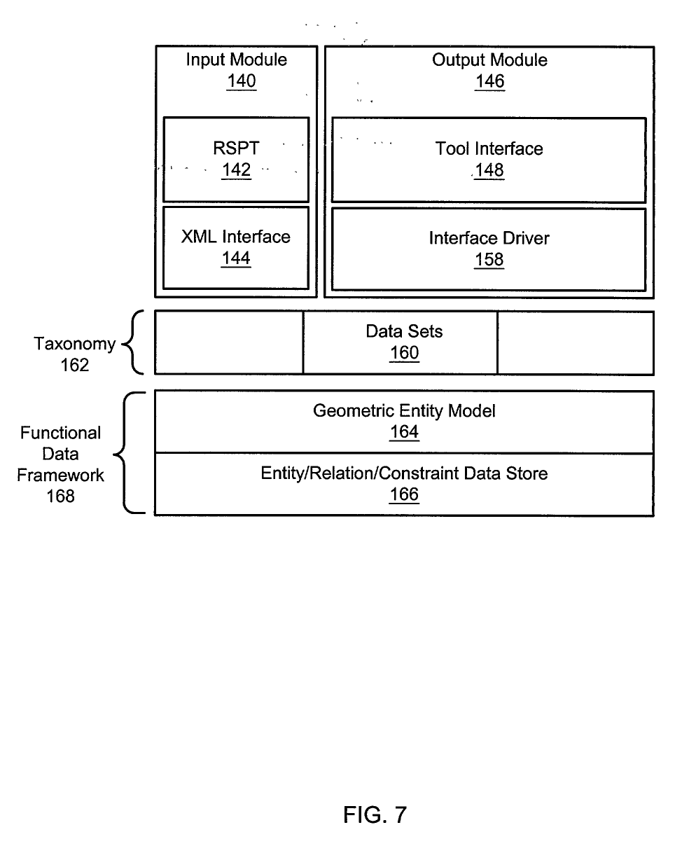

A designer may use the RSPT (92) to capture detailed, comprehensive requirements for a particular engineering project. These requirements may include necessary information such as entities and the attributes, relationships, and constraints of entities of the engineering project. For example, in the construction industry, a CAD package represents an air conditioning duct by a set of lines drawn in a certain way. A software tool that incorporates functional knowledge notes that the air conditioning duct is intended to convey air and notes the architectural, structural, and environmental regulations ramifications of the location of that duct. The information is stored in the AFK repository (105) in a manner to create functional knowledge as shown in FIG. 7 and described below.

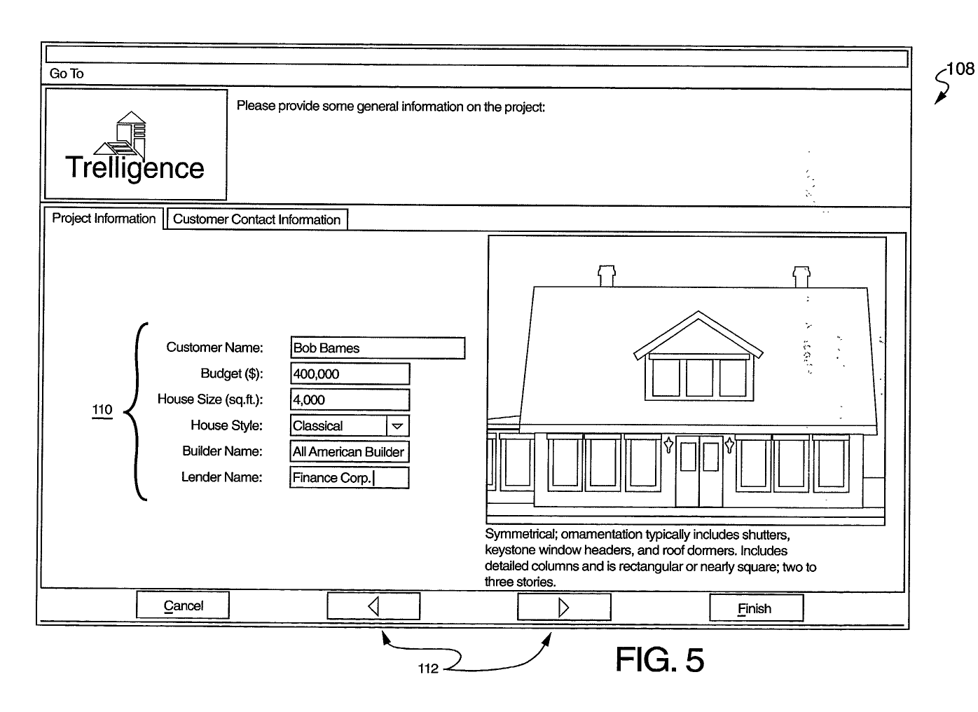

In one or more embodiments of the invention, as shown in FIG. 5, the requirements may be gathered from a customer using a graphical user interface (GUI) (108) that interactively requests the necessary information, such as project information (110) to capture the requirements of the engineering project. The project information (110) may include information such as customer name, budget, house size, house style, builder name, lender name, etc. The GUI (108) contains multiple pages for the customer to complete. The multiple pages may be accessed by using forward and backward arrows (112).

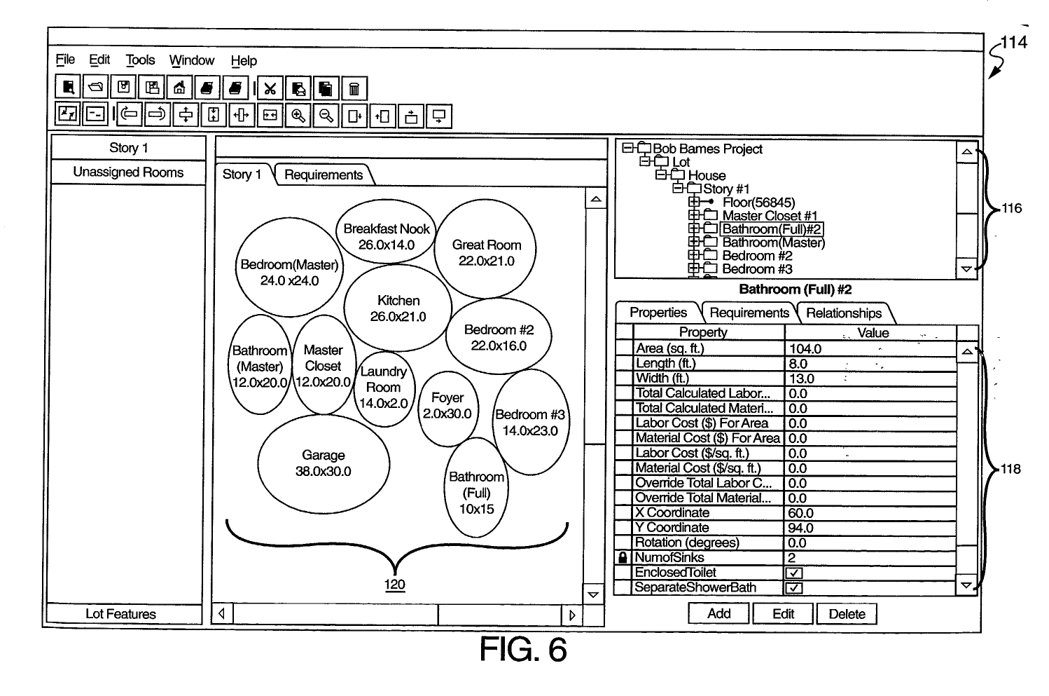

As shown in FIG. 6 in accordance with one or more embodiments of the invention, the designer may also use the RSPT (92) to generate and display a preliminary design as a GUI leveraging the information stored in the AFK repository (105). The information displayed within the preliminary design may be viewed and modified (e.g., changed, added, or deleted) by the designer, as desired. The GUI representation (114) of the preliminary design within the RSPT (92) includes space-holding objects (120), such as polygons or bubbles. Each space-holding object (120) has attributes, relationships, and constraints of a corresponding entity (or entities) as defined by the functional knowledge. A list of all entities may be viewed as a hierarchy of folders (116) that may be expanded to show the relationships, constraints, and properties of the particular project. By selecting a particular folder representing an entity (e.g., Bathroom (Full) #2), the attributes, relationships, and constraints (118) as stored in the AFK repository may be displayed in the GUI. These attributes, relationships, and constraints may be viewed and modified by a user of the RSPT (92).

As the information is modified in the preliminary design as displayed in the RSPT (92), the corresponding information in the AFK repository (105) is also modified accordingly via a direct interface (93), as needed. If a constraint of an entity (or entities) as defined by the functional knowledge is violated, the user of the RSPT (92) is notified by an alarm and/or a listing of all constraint violations (not shown). Once the designer has completed modifications to the preliminary design, the design, and all associated functional knowledge is exported from the RSPT (92) to the design tool (90).

Returning to FIG. 4, within the design tool (90), the designer creates a detail design that incorporates all the necessary design details to generate design documents to develop the engineering project. In necessary, the detail design may be revised by the designer through a series of design iterations. Any updates to the detail design using the design tool (90) are reflected on the preliminary design located within the RSPT (92). That is, as the detail design is being modified in the design tool (90), the GUI of the RSPT (92) (and the AFK repository (105)) is updated with any modification(s). The design tool (90) is not directly connected to the AFK repository (105), so an interface (94) between the RSPT (92) and the design tool (90) allows indirect access to the AFK repository (105).

In one or more embodiments of the invention, if any constraints of an entity or entities as defined in the functional knowledge is being violated by modifications made in the detail design, then the design tool (90) is able to provide feedback to the participant in the engineering process. In one or more embodiments of the invention, the designer may be alerted by a change in the appearance of a feature of a design or a list of all alerts is displayed.

After the exhaustion of the design iterations and the designer and customer approve the design, the design documents may be generated. The design documents reflect the requirements of the customer, the design skills of the designer, and the functional knowledge stored in the AFK repository. These design documents may include CAD drawings, object model diagrams, etc. that may be transferred to or accessed by project tools (89), such as the ET (96), the PMT (98), and the SCT (100). The design documents may also be transferred to the customer, suppliers, subcontractors, or any other party needing access to the documents via printed copies or in electronic form. For example, in the construction industry, a CAD package interacting with the RSPT (92) alerts the designer when constraints are violated, such as if the breakfast area is not big enough for a specific table planned to be located in the breakfast area, or the bedroom is smaller than the minimum required size of greater than 150 sq. ft., etc.

In one or more embodiments of the invention, the project manager or the designer may use the ET (96) to provide estimates for the entire engineering project or various portions of the engineering project at any point in time during the engineering process. The ET (96) is able to provide a detailed cost breakdown of the engineering project covering various facets of the project by accessing cost information associated with the and stored as an attribute of the entities. After gathering the requirements and while viewing the preliminary design, a cost estimate may be provided by the ET (96). This cost estimate is based primarily on factors supplied by the customer that are stored in the AFK repository (105), such as the size of the project and labor necessary to complete the project. Therefore, the cost estimate provided while viewing the preliminary design is a rough estimate. All the functional knowledge gathered and calculated regarding the costs associated with the engineering project is stored in the AFK repository (105). As the engineering project proceeds, the number of entities and the relationships, constraints, and attributes are better defined and the functional knowledge increases and estimates are more reliable.

Once the design documents are produced, the project manager or the designer is able to use the ET (96) to access enough information and functional knowledge stored in the AFK repository (105) to produce requests for proposals to be delivered to members of the supply chain during the bidding process. In one or more embodiments of the invention, the project manager or the designer is able to use the ET (96) to create detailed breakdowns of labor and/or material costs, which may be included in the design documents. These breakdowns allow the engineering firm the ability to provide precise quantities of the labor and/or material needed from the supply chain. The supply chain is then able to bid the engineering project more accurately.

At the same time and using the same information from the AFK repository (105), the project manager or the designer is able to use the ET (96) to provide the engineering firm with a more reliable cost estimate of the engineering project prior to commencing the bidding and/or development process. As modifications are made to the design documents during the course of the engineering project, the project manager or the designer is able to use the ET (96) to determine the impact of those modifications on the cost estimate.

The project manager uses the PMT (98) to manage bids by forwarding the request for proposals generated by the ET (96) (leveraging the function knowledge from the AKF repository (105)) to the supply chain. In one or more embodiments of the invention, the project manager uses the PMT (98) to compare the bids submitted by the supply chain and assesses the preferred bid based on criteria chosen by the engineering firm, e.g., lowest bidder, first to complete, meeting all requirements, etc. In one or more embodiments of the invention, the project manager or the designer uses the PMT (98) to select the bids based on the cost estimates provided by the ET (106) in conjunction with the functional knowledge in the AFK repository (105).

The project manager uses the PMT (98) to manage the necessary licenses for the engineering project. Based on the design documents and the functional knowledge in the AFK repository (105), the project manager uses the PMT (98) to determine the necessary licenses for the engineering process. Examples of the licenses managed by the PMT (98) include land permits in the construction industry or licensing agreements in the technology industry.

The project manager uses the PMT (98) to manage the development by having access to information about the supply chain and all tasks being performed by the supply chain by accessing the functional knowledge in the AFK repository (105). For example, in the construction industry, the project manager using the PMT (98) is able to contact the flooring contractor if the customer decides at the last minute to change the entryway from wood to tile. Further, the project manager uses the PMT (98) to simultaneously cause the design documents to be modified and notifies the supplier to cancel the wood flooring and order the sufficient amount of tile to fit in the entryway (in the style and color as modified in the requirements stored as functional knowledge in the AFK repository (105)).

The project manager also uses the PMT (98) to schedule the development leveraging the information in the AFK repository (105). Scheduling with access to the relationships and constraints defined by the functional knowledge allows the project manager using the PMT (98) to ensure that tasks are completed in logical progression and that conflicts between members of the supply chain are avoided.

For example, in the construction industry, the project manager using the PMT (98) is able to plan a schedule that ensures a deck is built and the electrical/plumbing work is completed prior to the installation of a hot tub. Further, the project manager is able to coordinate that the lumber for the deck arrives before the deck contractor arrives and that the electrician and plumber are not scheduled to install the connections to the hot tub at the same time.

The project manager uses the PMT (98) to update the AFK repository (105) on the state of the engineering project. For example, the project manager may use the PMT (98) to coordinate and manage the final inspection and closing. To schedule the final inspection, the project manager relies on relationships stating that the final inspection task may not be performed until after all other development tasks are completed. Likewise, to schedule the closing, the project manager relies on relationships stating that the closing task may not be performed until the final inspection is completed and approved. In addition, documents associated with and required by the final inspection and/or the closing may be produced based the functional knowledge stored in the AFK repository (105).

In one or more embodiments of the invention, the SCT (100) enables suppliers and/or subcontractors to access and interact with design document information stored in the AFK repository (105), including schedules, material lists, change orders, etc. The SCT (100) may also act as a management tool for suppliers and subcontractors to manage inventory, labor, etc.

The AFK repository holds functional knowledge and other information with regards to the engineering project. FIG. 7 shows a block diagram of the AFK repository in accordance with one or more embodiments of the invention. The AFK repository is intelligently stored such that the functional knowledge can be dynamically interfaced to a variety of data systems to be used in a variety of industries. Functional knowledge includes information about the valid entities in a space, the attributes of the entities, the relationships between these entities, and the constraints between the entities. The AFK repository includes an input module (140), an output module (146), and many layers of abstraction (166, 164, 162).

The input module (140) includes the RSPT (142) and the Extensible Markup Language (XML) interface (144). One skilled in the art will appreciate that the list of input modules is not exhaustive and as additional tools are created, additional interfaces may be added. The input module (140) provides multiple ways of gathering and recording the functional knowledge for an engineering project. The RSPT (92) is a tool used to gather requirements, including entities and the attributes, relationships, and constraints of entities of an engineering project. An XML output in the form of a schema file is generated from the gathered requirements using the XML interface (144). Then, the XML interface (144) exports the schema file to the AFK repository (105).

In one or more embodiments of the invention, the XML interface has the functionality to automatically generate and display questions for gathering requirements in the RSPT (92). Specifically, when a new dataset is added to the taxonomy layer (162) of the AFK repository (105), the XML interface uses a programming language, such as Java™, to create a graphical user interface in the form of a requirements questionnaire incorporating specific information defined by the taxonomy layer (162). In addition, the XML interface (144) may be used to interface with third party software to gather requirements of an engineering project through a web interface or any other graphical user interface.

The output module (146) includes many interfaces to external systems, stand-alone systems, and third party software. The output module (146) includes a tool interface (148) and an interface driver (158). One skilled in the art will appreciate that the tool interface (148) may include multiple tools and as additional tools are created, additional interfaces may be added. The interface driver (158) includes routines to extract information from the AFK repository and present the information in a standard format to external systems. The interface driver (158) also provides the necessary routines to notify third party applications of asynchronous changes in the AFK repository (105) as well as receiving asynchronous changes from external systems and updating the AFK repository (105), as needed. The tool interface (148) is implemented differently for each third party software to be interfaced to the AFK repository (105). The tool interface (148) is implemented using file formats and APIs available in the third party software. The output module (146) enables third party software to leverage the functional knowledge stored in the AFK repository using the interface driver (158). The output module (146) feeds critical project information to external systems without requiring extra input or other forms of communication from the designer.

In one or more embodiments of the invention, the interfaces may be part of a stand-alone application or interface with third party software. In one or more embodiments of the invention, the interface may be part of a software development kit (sdk). The sdk may have many versions such as broad-based sdk targeting the developer, an end-user sdk targeting the designer. The sdk provides the developer and/or the designer a mechanism to add new taxonomy. The end-user sdk provides the designer with a GUI to import or define further constraints for the project.

The layers of abstraction include the entity-relation-constraint data store (166), the geometric entity model (164), and the taxonomy (162), which capture the functional knowledge of the engineering project. The entity-relation-constraint data store (166) captures attributes of the entities, the relationships between the entities, and the constraints between the entities. The entities in the entity-relation-constraint data store represent requirements that apply to any engineering project. The geometric entity model (164) captures the physical properties and cost associated with the entities. The entity-relation-constraint data store (166) and the geometric entity model (164) grouped together form a functional data framework (168). The functional data framework represents the foundation and basic model of the AFK repository. The functional data framework remains constant, regardless of the industry leveraging the functional knowledge.

A taxonomy layer (162) with a dataset modeled to include the necessary information and constraints that apply to a particular industry forms a domain framework (170). The taxonomy layer (162) can handle multiple datasets at any given time. Thus, for the AFK repository (105) to be used for multiple industries, the dataset is modeled to include the necessary information about and constraints that apply to each industry. Due to the modular design of the AFK repository (105), only the taxonomy layer (162) requires modification in order for the AFK repository (105) to capture the functional knowledge of a particular industry and to allow the functional knowledge to be leveraged by that industry.

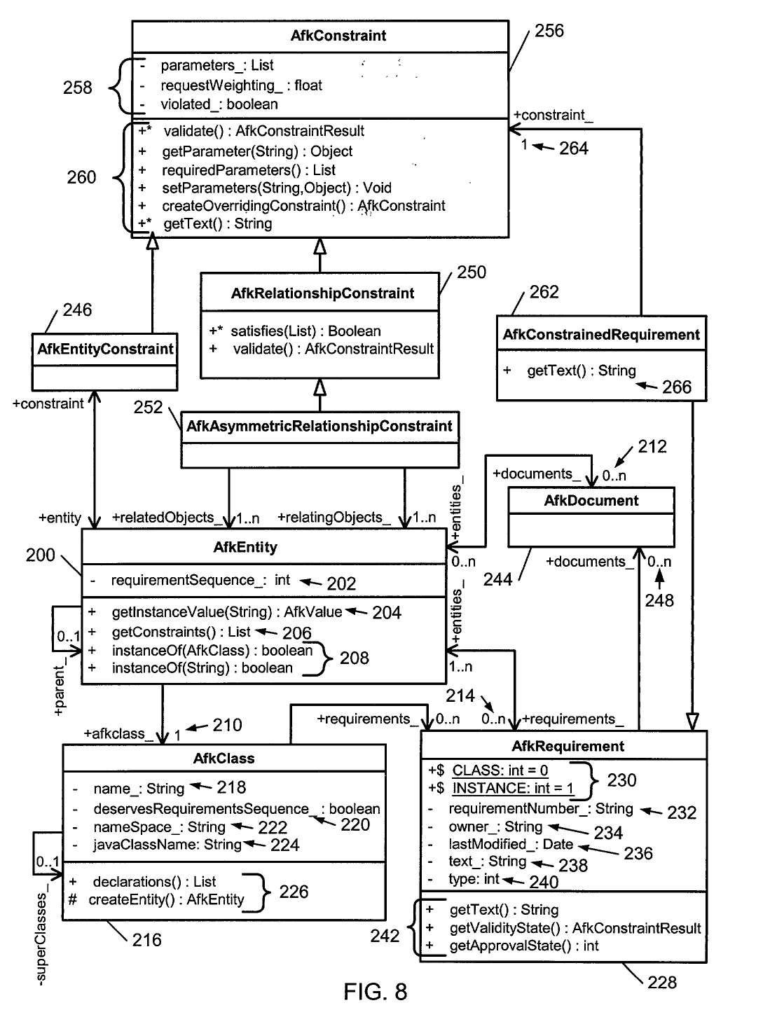

FIGS. 8-11 further describe the layers of abstraction using Unified Modeling Language (UML). UML is a graphical language for visualizing, specifying, constructing, and documenting the artifacts of an engineering system. Some of the common terms used in UML are class, attributes, operations, etc. A class is a description of a set of objects that share the same attributes, operations, relationships, and semantics. Graphically, a class is rendered as a rectangle. An attribute is a named property of a class that describes a range of values that instances of the property may hold. A class may have any number of attributes or no attributes at all. An operation is the implementation of a service that can be requested from any object of the class to affect behavior. A class may have any number of operations or no operations at all.

In UML, three kinds of relationships exist among classes: dependencies, generalization, and association. A dependency is a using relationship that states that a change in specification of one thing may affect another thing that uses the specification of the first thing. Graphically, a dependency is rendered as dashed directed line. A generalization is a relationship between a general thing (called the superclass or parent) and a more specific kind of that thing (called the subclass or child). Graphically, a generalization is rendered as solid line with a hollow arrowhead pointing to the parent. Association is a structural relationship that describes a set of connections among objects. Graphically, an association is rendered as a solid line, possibly directed, occasionally including a label, and often containing other adornments, such as multiplicity and role names.

In accordance with one or more embodiments of the invention, FIG. 8 shows a UML diagram of an entity-relation-constraint data store (166) in the AFK repository as shown in FIG. 7. The entity-relation-constraint data store (166) provides a mechanism to capture requirements, including entities and the attributes, relationships, and constraints of entities of the engineering project. The structure used to capture requirements for the entity-relation-constraint data store (166) is described below using the UML diagram of the entity-relation data store (166).

An Entity (200) class has a one-to-one association (210) to a Class (216), zero-to-n association (212) to a Document (244) class, zero-to-n association (214) to a Requirement (228) class, and an association to an EntityConstraint (246) class. The Class (216) has the attributes of name (218), deserveRequirementsSequence (220), namespace (222), and javaClassName (224). These attributes set the basic properties of a class. Also, the Class (216) has the declarations and createEntity operations (226).

The Requirement (228) class contains attributes that describe the owner (234), the last date the requirement was modified (236), requirement number (232), a container for the requirement (238), and the requirement type (240). The Requirement (228) class provides operations (242) to access the requirement and find the current state of the requirement. The Requirement (238) class has a zero-to-n association (248) to a Document (244) class. The Document (244) class provides a mechanism to associate documents with requirements or with an Entity (200) class.

The Entity (200) class has an association to the EntityConstraint (246) class. The constraint is logical paired with the entity. The RelationshipConstraints (250) is generalized into two separate classes, AsymmetricRelationshipConstraint (252) and SymmetricRelationshipConstraint (254). The RelationshipConstraints (250) shows how the constraints relate to other constraints. The RelationshipConstraint generalizes the Constraint (256) class. The Constraint (256) class has a few attributes (258) such as specify the weight of the constraint and whether the constraint has been violated or not. In addition, the Constraint (256) class has operations (260) such as get the constraint, set the constraint, etc. A ConstraintRequirement (262) class generalizes the Requirement (228) class and has a one-to-one association (264) with the Constraint (256) class. Thus, entity-relation-constraint data store (166) uses the described structure to capture a portion of the functional knowledge of an engineering project.

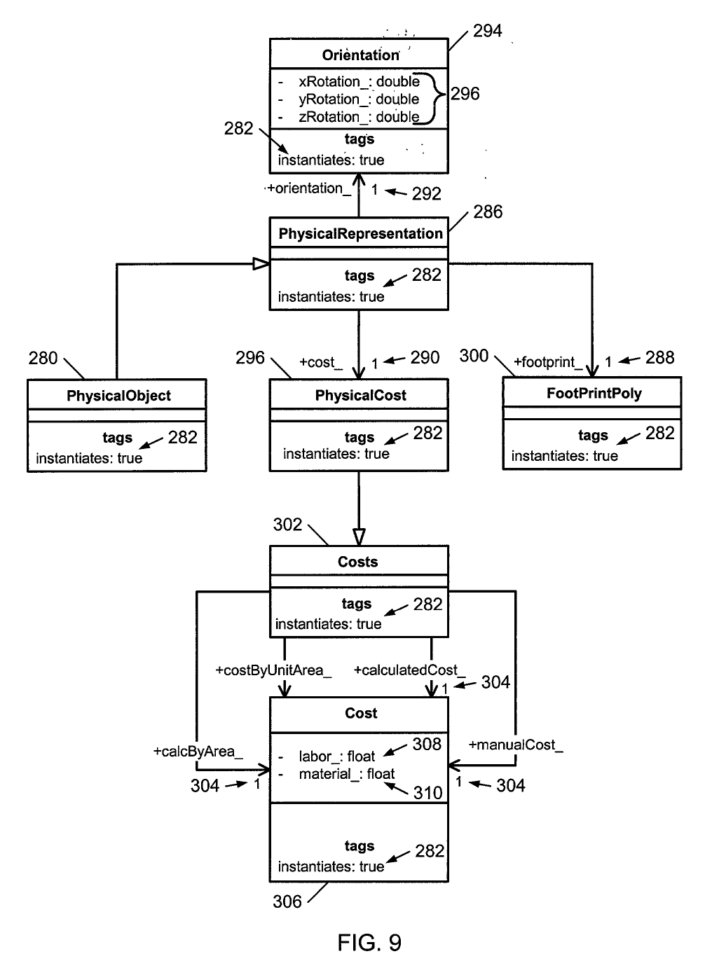

FIG. 9 shows a UML diagram of a geometric entity model (164) in the AFK repository (105) in accordance with one or more embodiments of the invention. The geometric entity model (164) encapsulates the physical objects of the engineering project such as position, rotation, 2D-plan view, etc. Cost is associated with every physical object in this model. For example, in the construction industry, a CAD drawing data is encapsulated at the geometric entity model (164). The structure used to encapsulate the physical objects for the geometric entity model (164) is described below using the UML diagram of the geometric entity model (164).

A PhysicalObject (280) generalizes a PhysicalRepresentation (292). Both of these classes have tags of instantiates (282). These tags are indicators that are used during the generation from the taxonomy to the actual classes to indicate additional information about the classes, including whether an attribute is optimized or not and parent/child relationships. An attribute is optimized when it includes a specialized method to efficiently implement certain operations. The PhysicalRepresentation (286) class has a one-to-one association (288, 290, 292) to the Orientation (294) class, PhysicalCost (296) class, and FootPrintPoly (300) class. The Orientation (294) class has x, y, and z coordinate attributes (296). The PhysicalCost (296) is a generalization of Costs. Each Costs class has a one-to-one association (304) to a Cost (306) class. The Cost (306) class has attributes of labor (308) and material (310). The labor (308) attribute holds the cost associated with the labor cost, while the material (310) attribute holds the cost associated with the material cost.

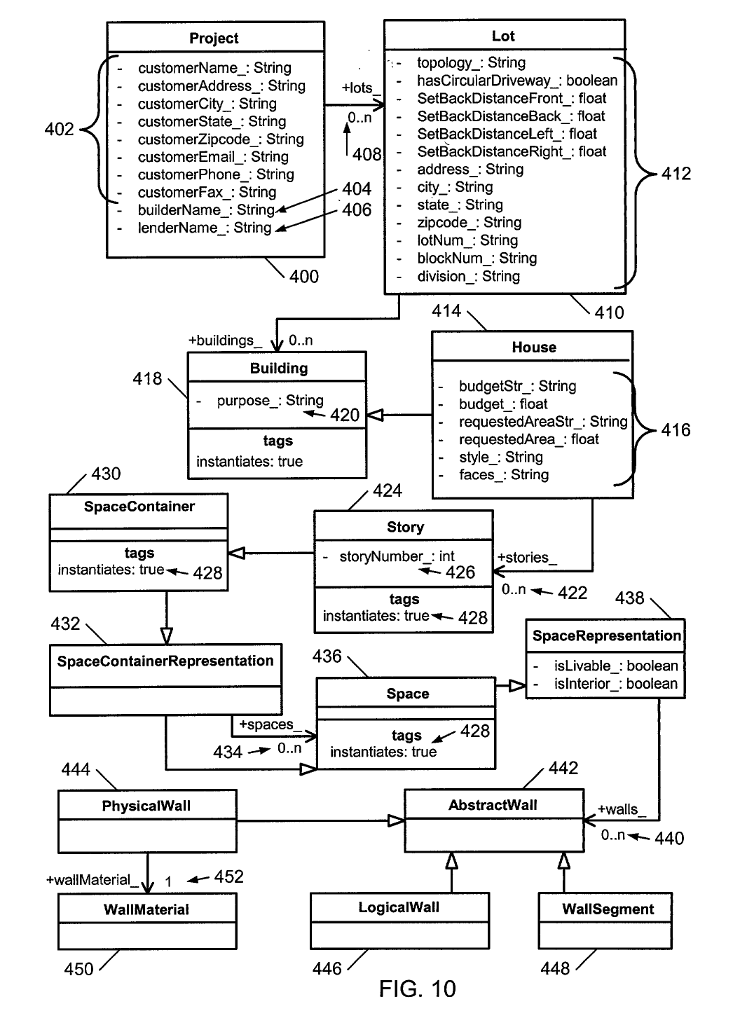

FIG. 10 shows a UML diagram of the taxonomy (162) in the AFK repository (105) depicting a model of a portion of the residential construction industry in accordance with one or more embodiments of the invention. The taxonomy (162) provides the engineering project with industry-specific datasets containing simple human understandable terms. In accordance with one or more embodiments of the invention, possible datasets (160) of the taxonomy (162) include code-check, energy efficiency design analysis, green building, feng shui, etc. One skilled in the art will appreciate that while FIG. 10 shows the taxonomy (162) for the residential construction industry, the taxonomy for each industry is unique and is modeled specifically for that industry. The structure used to capture datasets (160) for the taxonomy (162) is described below using the UML diagram of the taxonomy (162).

The base class is Project (400). The Project (400) class contains details about the customer contact information (402), builder's name (404), and lender's name (406). The Project (400) class has a zero-to-n association (408) to a Lot (410) class. The Lot (410) has attributes (412) that describe the lot details such as block number, lot number, etc.

The House (414) class generalizes the Building (418) class and has a zero-to-n association (422) to a Story (424) class. The house class as attributes (416) covering the basic size and style of the house. The Story (424) class generalizes a SpaceContainer (310) class. The Story (424) class holds the attribute of story number (426) of the house. The SpaceContainer (430) class generalizes a SpaceContainerRepresentation (432). The SpaceContainerRepresentation (432) has a zero-to-n association (434) to a Space (436) class. The Space (436) class generalizes the SpaceRepresentation (438) class. Each SpaceRepresentation (438) class has a zero-to-n association (440) to an AbstractWall (442) class. A PhysicalWall (444) class, a LogicalWall (446) class, and a WallSegment (448) class generalize the AbstractWall (442) class. The PhysicalWall (44) class has a one-to-one association (452) to a WallMaterial (450) class.

In accordance with one or more embodiments of the invention, the AFK repository (105) handles optimization either at the storage level or at the run-time class level. At run-time, the AFK repository (105) generates an optimized class with optimized attributes.

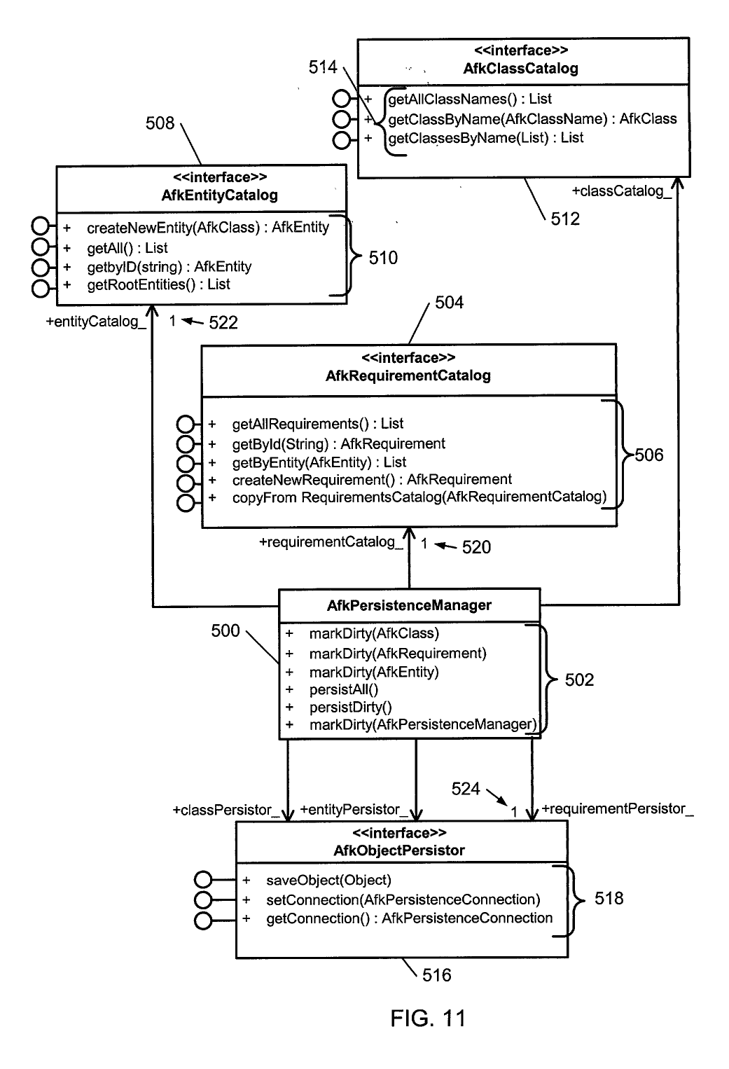

In accordance with one or more embodiments of the invention, FIG. 11 shows a UML diagram of the persistent mechanism in the AFK repository (105). The persistent mechanism enables the AFK repository (105) to be platform independent. The structure used to the persistence mechanism is described below using the UML diagram of the persistence mechanism.

The PersistenceManager (500) class manages the many different catalogs in the AFK repository. The PersistenceManager (500) has a one-to-one association (522) with an EntityCatalog (508), one-to-one association (520) with a RequirementCatalog (504), and an association with a ClassCatalog (512). These catalogs provide the ability to answer specific questions from the AFK repository such as a query in a database. The RequirementCatalog (504) provides operators (506) to obtain requirements by id or entity, obtain all requirements, and create new requirements. The EntityCatalog (508) provides operators (510) to create new entities, obtain all entities, and obtain entities by ID or the root entities. The ClassCatalog (512) provides operators (514), to obtain all classes and obtain classes by name. The PersistentManager (500) has a one-to-one association (524) with ObjectPersistor (516) class. The ObjectPersistor (516) provides operators (518) to set and obtain the connection to an object.

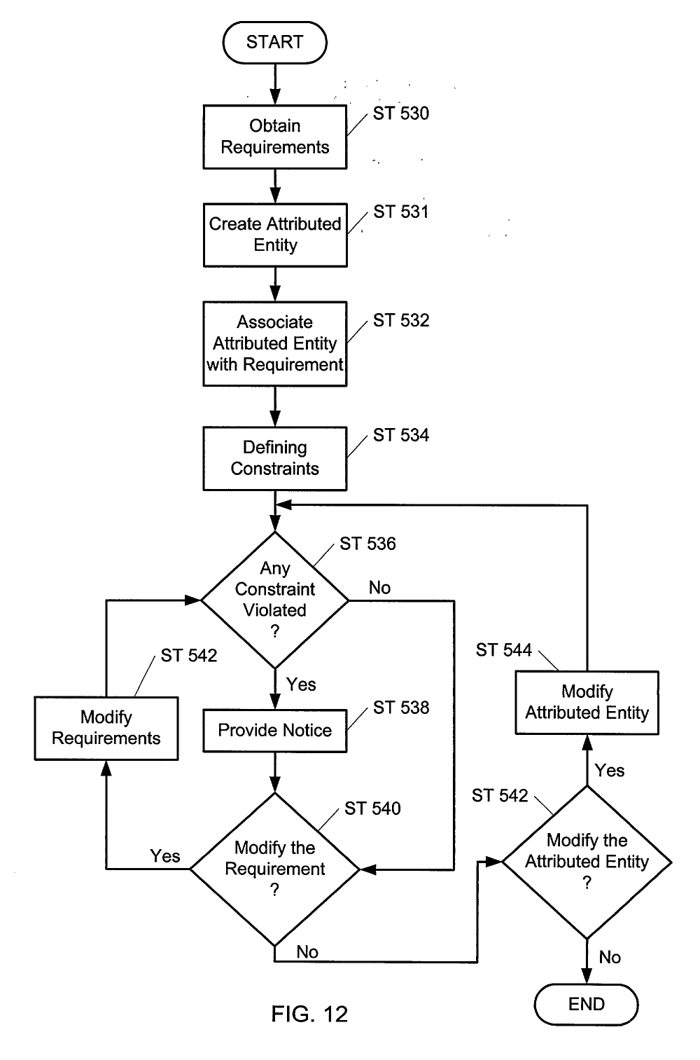

In one or more embodiments of the invention, FIG. 12 shows a flow chart of leveraging the functional knowledge in the AFK repository. Initially, requirements are obtained for the engineering project (Step 530). The requirements include necessary information about entities and the attributes, relationships, and constraints of entities. For example, the requirements for a construction project may include customer contact information, a budget for the project, the square footage of the structure, the model and size of a refrigerator, etc. The requirements may be obtained in a variety of formats from a variety of participants in the engineering project. For example, the requirements may be provided by the customer through a GUI or the requirements are provided through an interface from a stand-alone application (e.g., a design tool) from the designer.

Next, attributed entities are created (Step 531) that are necessary because of the requirements obtained, although some entities may not be associated with the requirements. Attributes are included within the entities defining the properties of the entities as defined by the AFK repository. In the construction industry, attributes may include such properties as a dimension of the room, a color of the carpet, etc. In one or more embodiments of the present invention, the attributes are associated with the requirements by storing the attributes in the AFK repository according to a UML model where a requirement class has a list of attributes that describe the requirement.

Next, attributed entities are associated with the requirements obtained in Step 530 (Step 532). The result of associating the entities and the requirements is the creation of attributed requirements.

Constraints are defined based on the attributed requirements (534). In one or more embodiments of the invention, the constraints may be obtained from the designer or customer using a GUI. The constraints are then stored in the AFK repository according to a UML model where a constraint may be defined for an entity and/or between entities. In the case where the constraint is defined for a single entity, then the attribute of the entity is constrained. Otherwise, if the constraint is defined for more than a single entity, then the relationship between the entities is constrained. The constraints are intended to keep the engineering project within the boundaries set by obtained requirements and/or other constraints defined by an industry-specific taxonomy dataset. In one or more embodiments of the invention, constraints may be defined by a stand-alone application or a third party software interfaced with the AFK repository.

If any constraint is violated (Step 536), notice is provided to a participant of the engineering process (Step 538). A constraint may be violated by falling outside the acceptable range of the constraints as defined in the AFK repository. For example, in the construction industry, a constraint is violated when the breakfast area is not big enough for a specific table planned to be located in the breakfast area, or the bedroom is smaller than the customer-defined minimum required size of greater than 150 sq. ft., etc. Notice may be provided in a variety of manners and with differing levels of participation by the participant of the engineering process. For example, the notice may be a simple alert in the form of a change in appearance of the violating constraint or a listing of the alerts within the design tool. A more complex alert may be a request of the participant to determine how to resolve (or not to resolve) the constraint.

Upon receiving the notice, a decision is required whether to modify the requirements to resolve the constraint that is being violated (Step 540). The decision to modify the entities and/or the attributes, relationships, and/or constraints of the entity may be decided automatically (based on pre-selected user settings) or may be decided by a participant in engineering process. If a decision is made to modify the requirements as stored in the AFK repository, then the requirement is modified (Step 542). In one embodiment of the invention, the modification of the violating constraints is performed using a GUI. Also, once the modification is performed, participants in the engineering process are informed of the modification.

A determination is also required as to whether to modify the attributed entity to resolve the constraint that is being violated (Step 544). The decision to modify the entities and/or the attributes, relationships, and/or constraints of the entity may be decided automatically (based on pre-selected user settings) or may be decided by a participant in engineering process. If a decision is made to modify the attributed entity as stored in the AFK repository, then the attributed entity is modified (Step 546). In one embodiment of the invention, the modification of the violating constraints is performed using a GUI. Also, once the modification is performed, participants in the engineering process are informed of the modification.

If a modification is performed in Step 542, the determination of whether any constraint is violated (Step 536) is re-visited and the process continues from that point. If no modification of attributed entity is desired or necessary (Step 544), the process is complete. Likewise, if no constraints are being violated (Step 536), no modification of requirements is desired or necessary (Step 540), and no modification of attributed entities is desired or necessary (Step 540), the process is complete.

In one or more embodiments of the invention, the project tools (89) as described in FIG. 4 are provided access to the requirements, including entities and the attributes, relationships, and constraints of entities of the engineering project as stored in the AFK repository.

Advantages of the present invention may include one or more of the following. The invention provides a more functional and accurate engineering process by leveraging the functional knowledge gathered in an AFK repository. The functional knowledge in the AFK repository enables the invention to provide more effective and accurate design, management, scheduling, estimation, and supply chain functions. The invention provides software tools that communicate customer requirements and design documents without changing current engineering processes or requiring the need to use new design tools. Functional knowledge stored in the AFK repository may be leveraged by any software used in any portion of the engineering process for any industry without requiring any modification to the software. In addition, the invention reduces the time a designer takes in the design phase because the majority of the design process is accomplished in the RSPT. A reduction of approximately 40% of designer time on design iterations is possible with the use of the invention during the design phase of the engineering process. In addition, a reduction of approximately 50% of the calendar time between the initial customer meeting and the signing of the contract may result. Those skilled in the art will appreciate that the present invention may have further advantages.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method of leveraging functional knowledge in an engineering project, comprising:
obtaining a first requirement of the engineering project;
creating a first attributed entity;
associating the first attributed entity with the first requirement to obtain a first attributed requirement;
obtaining a second requirement of the engineering project;
creating a second attributed entity;
associating the second attributed entity with the second requirement to obtain a second attributed requirement;
defining a plurality of constraints based on at least one of the first attributed requirement and the second-attributed requirement;
applying the plurality of constraints if one of the first attributed requirement and the second attributed requirement is modified; and
providing notice if at least one of the plurality of constraints is violated.

2. The method of claim 1, wherein providing notice comprises triggering an alert.

3. The method of claim 1, wherein providing notice comprises requesting an instruction of a participant of the engineering process.

4. The method of claim 1, further comprising:
modifying one of the plurality of constraints if at least one of the plurality of constraints is violated, wherein the providing notice comprises informing of the modifying of one of the plurality of constraints.

5. The method of claim 4, further comprising:
re-applying the plurality of constraints.

6. The method of claim 1, further comprising:
providing at least one of the first attributed entity, the first attributed requirement, the second attributed entity, the second attributed requirement, and the plurality of constraints.

7. The method of claim 6, wherein the providing comprises design document data to a design tool.

8. The method of claim 6, wherein the providing comprises management data to a project management tool.

9. The method of claim 6, wherein the providing comprises cost estimation data to an estimator tool.

10. The method of claim 6, wherein the providing comprises material and labor data to a supply chain tool.

11. A computer system to leverage functional knowledge in an engineering project, comprising:
a processor;
a memory;
a display device; and
software instructions stored in the memory for enabling the computer system under control of the processor, to perform:
obtaining a first requirement of the engineering project;
creating a first attributed entity;
associating the first attributed entity with the first requirement to obtain a first attributed requirement;
obtaining a second requirement of the engineering project;
creating a second attributed entity;
associating the second attributed entity with the second requirement to obtain a second attributed requirement;
defining a plurality of constraints based on at least one of the first attributed requirement and the second attributed requirement;
applying the plurality of constraints if one of the first attributed requirement and the second attributed requirement is modified; and
providing notice if at least one of the plurality of constraints is violated.

12. The computer system of claim 11, wherein the first requirement and the second requirement is displayed using a graphical user interface on the display device.

13. The computer system of claim 11, wherein providing notice comprises triggering an alert.

14. The computer system of claim 11, wherein providing notice comprises requesting an instruction of a participant of the engineering process.

15. The computer system of claim 11, further comprising software instructions, to perform:
modifying one of the plurality of constraints if at least one of the plurality of constraints is violated, wherein the providing notice comprises informing of the modifying of one of the plurality of constraints.

16. The computer system of claim 15, further comprising:
re-applying the plurality of constraints.

17. The computer system of claim 11, further comprising software instruction, to perform:
providing at least one of the first attributed entity, the first attributed requirement, the second attributed entity, the second attributed requirement, and the plurality of constraints.

18. The computer system of claim 17, wherein the providing comprises design document data to a design tool.

19. The computer system of claim 17, wherein the providing comprises management data to a project management tool.

20. The computer system of claim 17, wherein the providing comprises cost estimation data to an estimator tool.

21. The computer system of claim 17, wherein the providing comprises material and labor data to a supply chain tool.

22. An apparatus for leveraging functional knowledge in an engineering project, comprising:
means for obtaining a first requirement of the engineering project;
means for creating a first attributed entity;
means for associating the first attributed entity with the first requirement to obtain a first attributed requirement;
means for obtaining a second requirement of the engineering project;
means for creating a second attributed entity;
means for associating the second attributed entity with the second requirement to obtain a second attributed requirement;
means for defining a plurality of constraints based on at least one of the first attributed requirement and the second attributed requirement;
means for applying the plurality of constraints if one of the first attributed requirement and the second attributed requirement is modified; and
means for providing notice if at least one of the plurality of constraints is violated.

23. A system to leverage functional knowledge in an engineering process, comprising:
a functional knowledge repository created by modeling a plurality of requirements of the engineering project; and
a plurality of project tools interfacing with the functional knowledge repository.

24. The system of claim 23, wherein the functional knowledge repository comprises:
a plurality of abstraction layers modeling a plurality of requirements of the engineering project;
an input module allowing the input of the plurality of requirements into the plurality of abstraction layers; and
an output module allowing leveraging of the plurality of requirements from the plurality of abstraction layers.

25. The system of claim 23, wherein the plurality of project tools comprises at least one selected from the group consisting of a requirement space planning tool, a project management tool, an estimator tool, and a supply chain tool.

26. The system of claim 23, wherein the plurality of project tools comprises a third party software.

27. The system of claim 23, wherein the plurality of project tools comprises a standalone application with an interface.

28. The system of claim 25, wherein the requirements space planning tool comprises a component to gather the plurality of requirements and a component to generate a preliminary design.

29. An applied functional knowledge repository, comprising:
a plurality of abstraction layers modeling a plurality of requirements of an engineering project;
an input module allowing the input of the plurality of requirements into the plurality of abstraction layers; and
an output module allowing leveraging of the plurality of requirements from the plurality of abstraction layers.

30. The applied functional knowledge repository of claim 29, wherein the plurality of abstraction layers comprise at least one of the group consisting of an entity-relation-constraint data store, a geometric entity model, and a taxonomy.

31. The applied functional knowledge repository of claim 30, wherein the entity-relation-constraint data store captures information about a plurality of entities, relationships between the plurality of entities, and constraints between the plurality of entities.

32. The applied functional knowledge repository of claim 30, wherein the geometric entity model captures physical properties and cost associated with a plurality of entities.

33. The applied functional knowledge repository of claim 30, wherein the entity-relation-constraint data store and the geometric entity model comprise a functional data framework.

34. The applied functional knowledge repository of claim 33, wherein the functional data framework remains constant despite which industry is leveraging the functional knowledge repository.

35. The applied functional knowledge repository of claim 30, wherein the taxonomy comprises a dataset modeled for an industry leveraging the functional knowledge repository.

36. The applied functional knowledge repository of claim 29, wherein the input module comprises a requirements space planning tool and an extensible mark-up language interface.

37. The applied functional knowledge repository of claim 29, wherein the output module comprises interfaces to stand-alone applications.

38. The applied functional knowledge repository of claim 29, wherein the output module comprises interfaces to a third party software.

39. The applied functional knowledge repository of claim 29, wherein the plurality of abstraction layers is optimized.

40. The applied functional knowledge repository of claim 29, wherein the plurality of abstraction layers employs a persistent mechanism to enable platform independence.
